(19) United States
(12) Patent Application Publication
(10) Pub. No.: US 2021/0301527 A1
(43) Pub. Date: Sep. 30, 2021

(54) PREFABRICATED PANEL WITH MULTI-LAYER CEMENTITIOUS COVERINGS

(71) Applicant: NEXII BUILDING SOLUTIONS INC., Vancouver (CA)

(72) Inventors: Michael Anthony DOMBOWSKY, Moose Jaw (CA); Benedict John DOMBOWSKY, Moose Jaw (CA); Mark Benedict DOMBOWSKY, Moose Jaw (CA); Braden Louis DOMBOWSKY, West Kelowna (CA)

(21) Appl. No.: 17/214,687

(22) Filed: Mar. 26, 2021

Related U.S. Application Data
(60) Provisional application No. 63/000,942, filed on Mar. 27, 2020.

(51) Int. Cl. E04C 2/288; B28B 1/16; B28B 23/02

(52) U.S. Cl. CPC E04C 2/288; E04B 1/86; B28B 23/02; B28B 1/16

(57) ABSTRACT

Example embodiments of the described technology provide a prefabricated building panel. The prefabricated building panel may comprise an insulative core having first and second opposing faces. The prefabricated building panel may also comprise a first cementitious layer coupled to the first face of the insulative core. The first cementitious layer may comprise a volume of a first cementitious composition. The prefabricated building panel may also comprise a second cementitious layer coupled to the first cementitious layer. The second cementitious layer may comprise a volume of a second cementitious composition. The first and second cementitious compositions may have different physical properties. The physical properties may be selected from the group consisting of density, fire resistance, sound transmission, structural strength and moisture permeability.

### CROSS-REFERENCE TO RELATED APPLICATIONS

This application claims the benefit under 35 U.S.C. § 119 of U.S. application No. 63/000,942 filed 27 Mar. 2020 and entitled PREFABRICATED PANEL WITH MULTI-LAYER CEMENTITIOUS COVERINGS which is hereby incorporated herein by reference for all purposes.

### TECHNICAL FIELD

This invention relates to building panels and in particular cementitious prefabricated building panels such as Concrete Structural Insulated Panels. Example embodiments provide systems and methods for covering an insulative core with different combinations of cementitious coverings to achieve desired performance characteristics.

### BACKGROUND

Constructing a building is typically an extensive project involving significant amounts of time and/or resources (labour, energy, materials, etc.). Moreover, the carbon footprint of a building built using existing systems and methods can be large.

Reducing the amount of time and/or resources required to construct a building can be desirable. Reducing the carbon footprint of a building can also be desirable. With more environmentally stringent building codes being passed regularly, reducing the amount of resources used to construct a building and the carbon footprint of the building is increasingly becoming a requirement to be in compliance with new building codes.

One way the amount of time and/or resources required can be reduced is by constructing the building using prefabricated panels. Existing prefabricated panels however are heavy, cannot provide the required performance characteristics, etc. Additionally, existing prefabricated panels may be difficult to maneuver into place and to couple together.

There remains a need for practical and cost effective ways to construct prefabricated building panels using systems and methods that improve on existing technologies.

### SUMMARY

This invention has a number of aspects. These include, without limitation:
cementitious coverings for achieving desired performance characteristics of a prefabricated panel;
methods for constructing a prefabricated panel.

Further aspects and example embodiments are illustrated in the accompanying drawings and/or described in the following description.

### BRIEF DESCRIPTION OF THE DRAWINGS

The accompanying drawings illustrate non-limiting example embodiments of the invention.

FIG. 1 is a perspective schematic illustration of a prefabricated panel according to an example embodiment of the invention.

FIG. 2 is a partial cut-away perspective view of the FIG. 1 panel.

FIG. 3 is a partial cut-away perspective view of a prefabricated panel according to another example embodiment of the invention.

FIG. 4 is a partial cross-sectional view of the FIG. 3 panel along lines A-A.

FIG. 5 is a perspective schematic illustration of example decorative features coupled to a prefabricated panel according to an example embodiment of the invention.

FIG. 6 is a block diagram illustrating a method according to an example embodiment of the invention.

### DETAILED DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive sense.

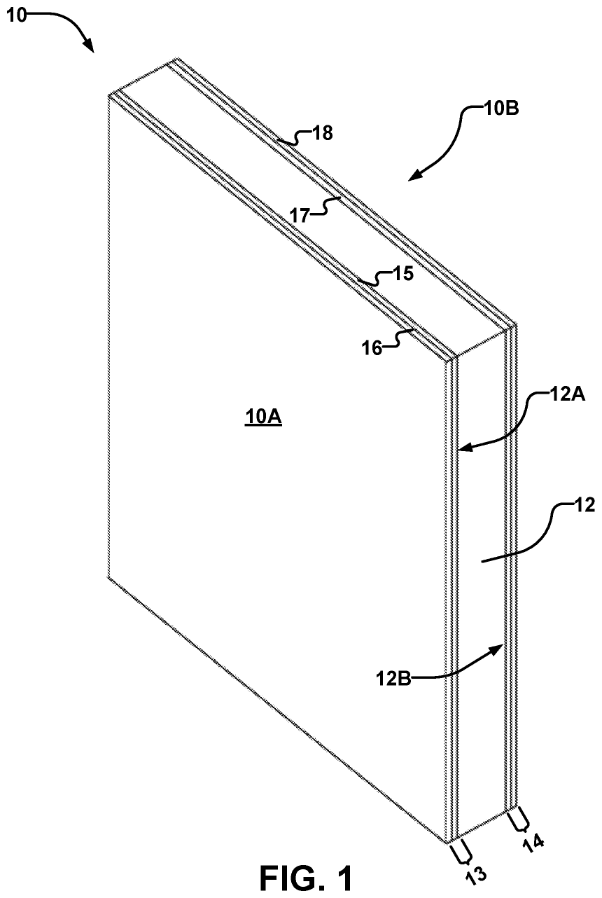

FIG. 1 schematically shows an example prefabricated panel 10 having opposing faces 10A and 10B. A set of panels 10 may be used to construct a building, to insulate an existing building and/or the like. Preferably panels 10 are plant finished (e.g. fully manufactured at a factory). Panels 10 may also preferably be easily and quickly shipped to a construction site (e.g. on a flatbed truck, within shipping containers, on railway cars, etc.). Once panels 10 arrive at the construction site they may be easily and quickly assembled together.

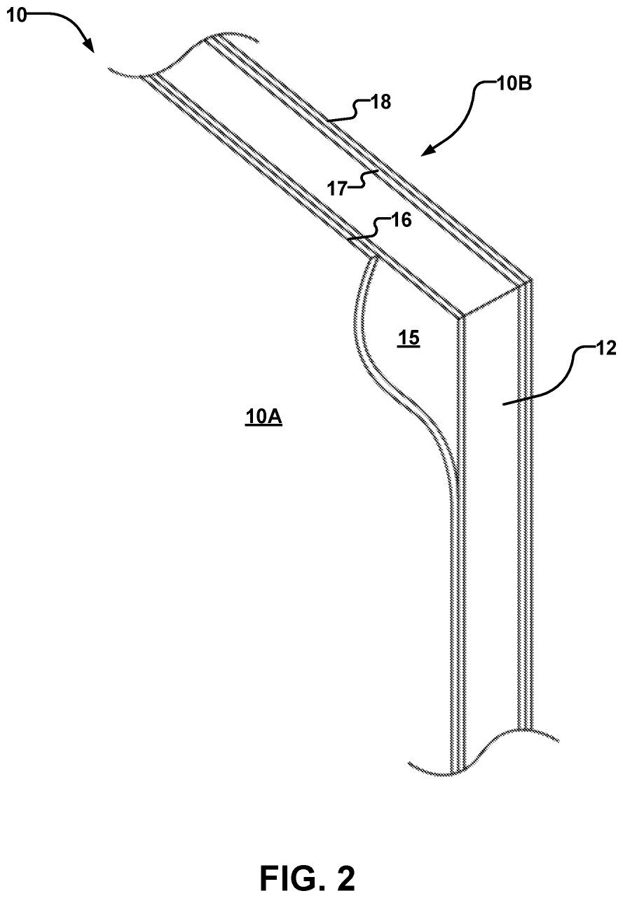

As shown in FIG. 1, panel 10 comprises an insulative core 12 having opposing faces 12A and 12B. Insulative core 12 provides a thermal break between face 10A and face 10B of panel 10. Insulative core 12 may also at least partially structurally support panel 10. Insulative core 12 may also at least partially dampen sound transmission through panel 10. Insulative core 12 preferably comprises a single piece of insulation. However, this is not necessary. In some embodiments insulative core 12 is made of two or more pieces of insulation. FIG. 2 is a partial cut-away perspective view of panel 10.

In some embodiments insulative core 12 is made of rigid foam insulation. In some embodiments insulative core 12 is made of expanded polystyrene (EPS), polyisocyanurate (polyiso), extruded polystyrene (XPS) and/or the like. In some embodiments insulative core 12 is at least partially made of mineral fiber rigid insulation. In some embodiments insulative core 12 is at least about 3 inches thick (e.g. for warmer climates, etc.). In some embodiments insulative core 12 is at least about 24 inches thick (e.g. to comply with passive housing standards, for cold climates, etc.). In some embodiments insulative core 12 is between 3 and 24 inches thick.

Insulative core 12 typically has an insulative R-value of about R4 per inch. In some embodiments insulative core 12 has an insulative R-value of at least R12. In some embodiments insulative core 12 has an insulative R-value of at least R96. In some embodiments insulative core 12 has an insulative R-value between R12 and R96.

Faces 12A, 12B of insulative core 12 may be at least partially covered by cementitious coverings 13, 14 respectively. The inventors have discovered that by covering at least one of faces 12A and 12B with a cementitious covering as described herein, desirable performance characteristics (e.g. fire protection characteristics, sound dampening characteristics, structural support characteristics, moisture permeability characteristics, etc.) for panel 10 are obtainable. However, different cementitious materials which may make up the cementitious covering(s) have different performance characteristics. Some cementitious materials have higher fire protection and/or sound dampening performance while having reduced structural support characteristics. Some cementitious materials have higher structural support characteristics and/or reduced moisture permeability while having reduced fire protection and/or sound dampening performance.

By covering a face of the insulative core of the panel with a cementitious covering which comprises a plurality of cementitious layers made of different cementitious materials, the inventors have discovered that it is possible to make a panel which has desirable performance characteristics which would not otherwise be attainable if the cementitious covering comprised only a single type of cementitious material.

Cementitious coverings 13, 14 may each comprise a layer made of a lower density cementitious material (e.g. layers 15, 17) and a layer made of a higher density cementitious material (e.g. layers 16, 18). Similar layers (e.g. layers 15, 17) may be made of the same or different cementitious materials.

The layers made of the lower density (e.g. 5-35 megapascals (MPa)) cementitious material(s) may provide high fire protection characteristics (e.g. at least 2 hours at 1800 degrees Fahrenheit, is compliant with fire resistant standards (e.g. CAN/ULC-S101 Fire-Resistance Ratings, etc.) and/or the like) and/or high amounts of sound dampening (e.g. at least 50 STC (sound transmission class)). However, the lower density cementitious materials typically do not provide large amounts of structural strength. The lower density cementitious materials may also have increased moisture permeability.

Typically, the lower density cementitious material comprises cement, at least one polymer and at least one aggregate. In some embodiments the lower density cementitious material comprises calcium sulfoaluminate (CSA) cement, a polymer and perlite. Additionally, or alternatively, the lower density cementitious material may comprise vermiculite, ceramic and/or the like.

The layers made of the higher density (e.g. 35-90 MPa) cementitious material(s) provide increased amounts of structural strength (e.g. a compressive strength in the range of about 120 to 160 Pound-force per Cubic Foot (PCF)). In some embodiments the higher density cementitious material has a density in the range of about 90 to 200 MPa and provides even higher amounts of structural strength. Advantageously, the higher density cementitious materials may also have a lower moisture permeability (e.g. a water absorption coefficient according to standard ASTM C1794 in the range of about 0.00019 to 0.0031 kg/m²s^{0.5}, a vapor permeance of less than about 2 US perms, a vapor permeance rating compliant with ASTM E96 in the range of about 0.19 to 0.24 US perms, etc.) than the lower density cementitious materials. However the higher density cementitious materials typically provide reduced fire protection and/or sound dampening.

Typically the higher density cementitious material comprises cement and at least one polymer. In some embodiments the higher density cementitious material comprises CSA cement and a polymer. Varying an amount of and/or the type of the polymer may vary moisture permeability of the higher density cementitious material (e.g. increasing an amount of the polymer may decrease moisture permeability, etc.). Additionally, or alternatively, adding one or more additives to the higher density cementitious material may decrease moisture permeability.

In some embodiments the lower density cementitious material has a density of at most about 35 MPa. In some embodiments the lower density cementitious material has a density of at most 90 Pound-force per Cubic Foot (PCF). In some embodiments the lower density cementitious material has a density in the range of about 5 to 90 PCF. In some embodiments the lower density cementitious material has a density in the range of about 70 to 90 PCF.

The higher density cementitious material may have a density that is about 3 to 12 times greater than the density of commercially available standardized foamed concrete or Air Crete. In some embodiments the higher density cementitious material has a density of at least about 35 MPa. In some embodiments the higher density cementitious material has a density of at least 90 PCF. In some embodiments the higher density cementitious material has a density in the range of about 90 to 160 PCF.

FIGS. 1 and 2 show lower density cementitious layers 15, 17 covering faces 12A, 12B of insulative core 12 respectively. Higher density cementitious layers 16, 18 are shown as covering lower density cementitious layers 15, 17 respectively. Such ordering of layers is not mandatory. It is also not mandatory that faces 12A and 12B are covered by similar cementitious coverings. It is also not mandatory that both faces 12A and 12B are covered by a cementitious covering as described herein. In some embodiments one of face 12A and 12B may comprise no cementitious covering or may be covered by a single layer comprising a single cementitious material. It is also not mandatory that faces 12A and/or 12B are covered with exactly two cementitious layers.

In some embodiments a higher density cementitious layer (e.g. layer 16 or 18) covers a face of the insulative core and a lower density cementitious layer (e.g. layer 15 or 17) covers the higher density cementitious layer. In such embodiments, the lower density cementitious layer may provide increased fire protection to both the insulative core and the higher density cementitious layer. Additionally, or alternatively, having the lower density cementitious layer cover the higher density cementitious layer may increase an amount of sound dampening (i.e. provide a greater sound barrier) provided by the cementitious layers. Additionally, or alternatively, having the lower density cementitious layer cover the higher density cementitious layer may provide a desirable outer surface for inserting fasteners (e.g. nails, screws, etc.) into the panel.

In cases where a cementitious covering is likely to be exposed to moisture (e.g. in circumstances where the cementitious covering at least partially forms an external wall surface, in circumstances where the cementitious covering at least partially forms an inner wall surface for example of an indoor pool facility, etc.) it may be preferable for a higher density cementitious layer (e.g. layer 16 or 18) to be the outermost layer of the cementitious covering in view of the reduced moisture permeability properties provided by the higher density cementitious material.

To avoid introducing any thermal bridges within panel 10 the cementitious layers (e.g. layers 15, 16, 17, 18) which make up cementitious coverings 13, 14 are preferably directly coupled to faces 12A, 12B of insulative core 12 and/or adjacent cementitious layers. For example, the cementitious layers may be wet-bonded to each other and/or faces of the insulative core (e.g. the cementitious layers “self-adhere” to each other and/or the faces of the insulative core). The wet-bonding provides an adhesive chemical bond directly between two surfaces that are to be coupled together (e.g. a face of the insulative core and a cementitious layer, between two cementitious layers, etc.).

In some embodiments the cementitious layers are at least partially coupled to each other and/or the insulative core using one or more ties (e.g. commercially available “delta ties”, commercially available insulated concrete form ties, etc.) which extend at least partially through the panel. The ties may be made of a material which has a low thermal conductivity (i.e. the tie does not create a thermal bridge). The ties may be made of a suitable plastic, carbon fiber, fiberglass and/or the like.

In some embodiments one or both of cementitious coverings 13, 14 cover at least a majority (greater than 50%) of the surface area of faces 12A, 12B of insulative core 12 respectively. In some embodiments one or both of cementitious coverings 13, 14 cover at least 55%, 60%, 65%, 70%, 75%, 80%, 85% or 90% of the surface area of faces 12A, 12B of insulative core 12 respectively. In some embodiments one or both of cementitious coverings 13, 14 cover substantially all of the surface area of faces 12A, 12B of insulative core 12 respectively. “Substantially all” means at least 95%.

Cementitious coverings 13, 14 may have the same or different thicknesses. Cementitious coverings 13, 14 may cover similar or different amounts of surface area. In preferred embodiments cementitious coverings 13, 14 have thicknesses that are significantly less than a thickness of insulative core 12. “Significantly less” means at least 5 times less.

Cementitious layers 15, 16, 17 and 18 may cover similar or different amounts of surface area. Cementitious layers 15, 16, 17 and 18 may have the same or different thicknesses. In some embodiments similar cementitious layers (e.g. lower density cementitious layers 15, 17) may have similar thicknesses and/or cover similar amounts of surface area. In some embodiments at least one of cementitious layers 15, 16, 17 and 18 has a thickness in the range of about 0.2 inches to 2 inches.

A cementitious layer (e.g. cementitious layer 15, 16, 17 and 18) need not have a uniform thickness. The cementitious layer may be thicker in some portions compared to other portions of the layer. For example, portions of a lower density cementitious layer which cover a fire sensitive area of panel 10 may be thicker than other portions of the layer. As another example, a portion of a cementitious layer may be thinner in areas surrounding an attachment to be coupled to panel 10 (e.g. a utility box, utility meter, etc.) than other portions of the layer to provide adequate space for the attachment.

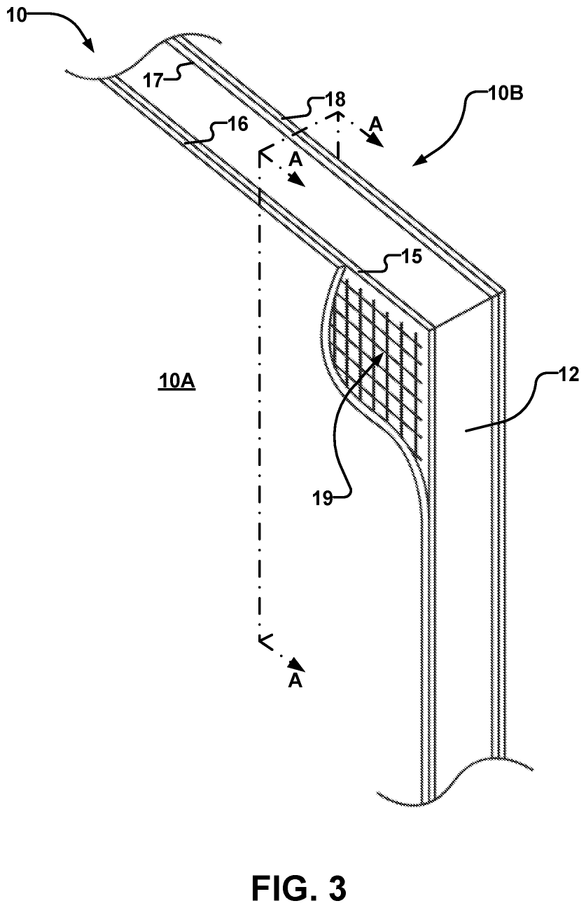

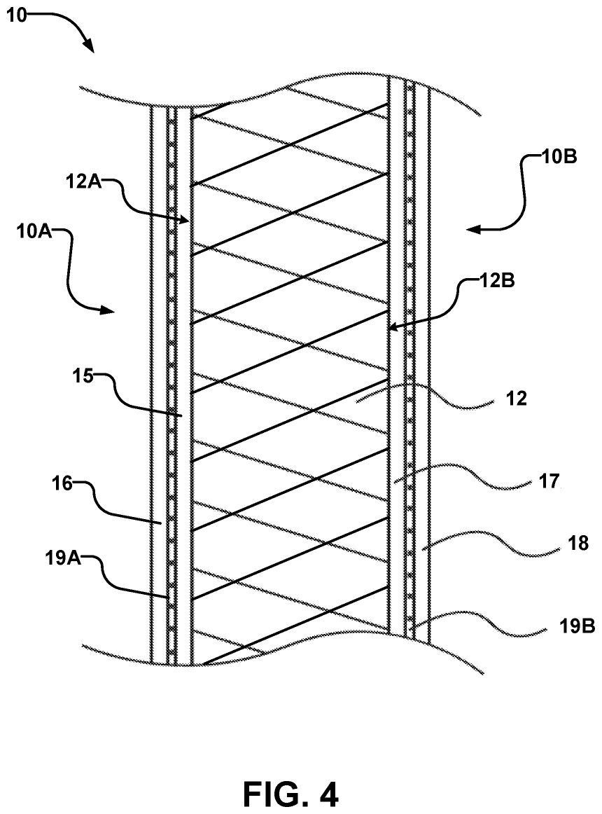

In some embodiments one or both of cementitious coverings 13 and 14 comprise reinforcing members 19A and 19B (collectively reinforcing members 19) as shown in FIGS. 3 and 4. FIG. 4 is a partial cross-sectional view of a portion of panel 10 along the plane formed by lines A-A of FIG. 3.

Advantageously, reinforcing members 19 may increase structural strength of the cementitious coverings, prevent cracking of the cementitious coverings and/or the like. Although FIGS. 3 and 4 show reinforcing members 19 positioned between the different cementitious layers, this is not necessary. In some embodiments a reinforcing member 19 is embedded more within one cementitious layer than another cementitious layer. In some embodiments a reinforcing member 19 may be embedded within each cementitious layer (e.g. a reinforcing member 19 per cementitious layer). In some embodiments reinforcing members 19 are included throughout an entire panel 10. However reinforcing members 19 need not be included throughout an entire panel 10 in all cases.

Reinforcing members 19 may be made of:
expanded metal mesh (EMM);
welded wire mesh (WMM);
fiberglass mesh;
basalt mesh and/or rebar;
carbon fiber mesh and/or rebar;
carbon nanotubes;
Kevlar;
steel and/or stainless steel rebar;
etc.

In some embodiments reinforcing members 19 may comprise a plurality of fibers. For example, reinforcing members 19 may comprise a plurality of polymer fibers, a plurality of fiberglass fibers, a plurality of basalt fibers, a plurality of carbon fiber fibers and/or the like.

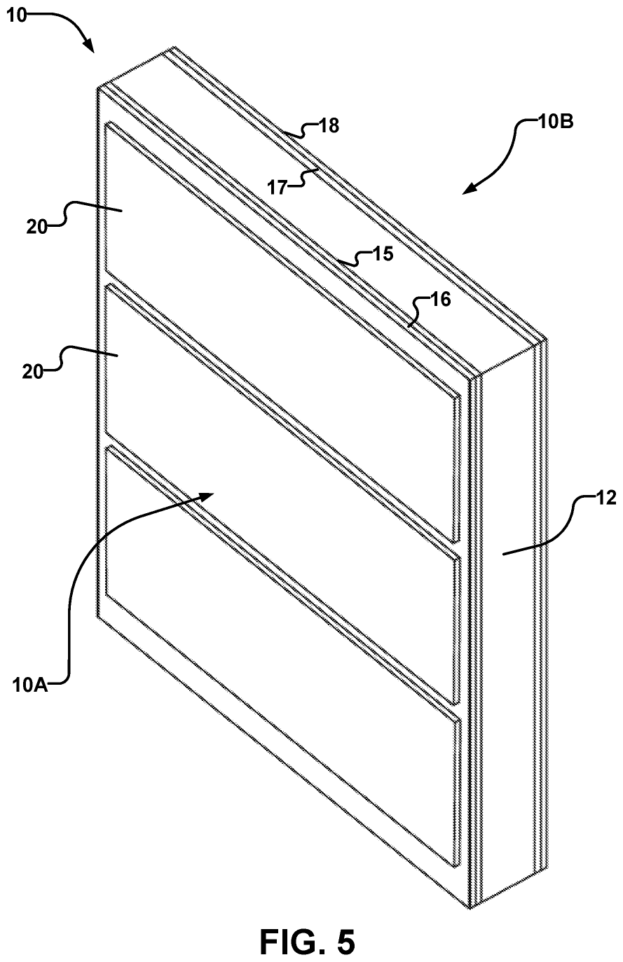

Decorative features (cladding, molding, etc.) may be coupled to an outer cementitious layer of panel 10. For example, FIG. 5 shows example cladding 20 coupled to surfaces of face 10A of panel 10. Additionally, or alternatively, an outer cementitious layer of panel 10 may be finished to replicate commonly used building materials such as drywall or the like.

Higher performance characteristics for a panel 10 may be desirable over only select portions of panel 10. In such cases a cementitious layer may cover only select portions of panel 10. Such cementitious layer may be the inner or outer layer. In some cases, such cementitious layer which only covers select portions of panel 10 to provide the desired performance characteristics may also provide a decorative feature. Such cementitious layer may, for example, be cast into a decorative window trim, molding, etc.

For example, it may only be necessary to increase the strength of panel 10 around openings in panel 10 such as openings for windows, doors, etc. In such cases, the higher density cementitious layer may only cover the portions of face 10A and/or 10B of panel 10 which surround the openings. The higher density cementitious layer may be the inner or outer cementitious layer. As described elsewhere herein, the higher density cementitious layer may, for example, be formed into a decorative trim which surrounds the opening.

In some embodiments a cementitious layer is not continuous. In some such embodiments one cementitious layer may be cast into strips (e.g. horizontal strips, vertical strips, etc.). A second cementitious layer may cover the strips of the other cementitious layer. The second cementitious layer may also fill in gaps between adjacent strips of the other cementitious layer. For example, an inner layer adjacent a face of insulative core 12 may consist of strips of the higher density cementitious material. An outer layer comprising the lower density cementitious material may cover the higher density cementitious material. The outer layer may also fill in gaps between adjacent strips of the inner layer. In some embodiments the gaps are unfilled however. In some embodiments spacers and/or the like are installed between adjacent strips of the inner layer.

Although panel 10 has been shown as comprising two cementitious layers which cover faces 12A and 12B of insulative core 12, any different number of cementitious layers (e.g. two or more layers covering each face, at least one layer covering a face, two or more layers covering one face and at least one layer covering the other face, etc.) may cover one or both of faces 12A and 12B depending on desired characteristics for a panel. For example, a panel may comprise three different layers which cover a face of insulative core 12. In such example case, a first layer may provide increased fire resistance, a second layer may provide increased structural strength and a third layer may provide increased sound dampening.

Another aspect of the invention provides a method for making panels 10 described elsewhere herein.

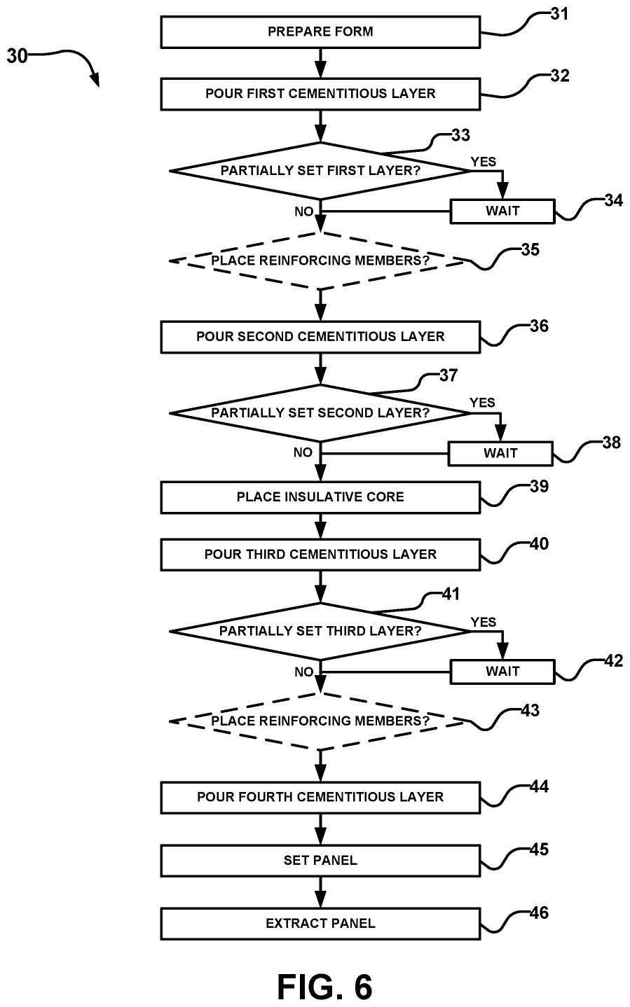

FIG. 6 is a block diagram showing an example method 30 for making an example panel 10.

In block 31 a form for casting the panel is prepared. The form may comprise one or more features to assist with extraction of a completed panel. Such features may include rounded interior corners, formwork that may be quickly uncoupled, etc.

In block 32 a first cementitious composition is poured into the form to cast a first cementitious layer (e.g. layer 16). Block 33 determines whether method 30 should wait for a set amount of time to allow the first cementitious layer to at least partially set before proceeding with the construction of the panel. If yes, method 30 proceeds to block 34 where method 30 waits for a set amount of time to pass. Otherwise method 30 proceeds to optional block 35.

In block 35 one or more reinforcing members (e.g. reinforcing members 19A) are positioned within the form.

A second cementitious composition may be poured over the first cementitious layer to cast a second cementitious layer (e.g. layer 15) in block 36. Block 37 determines whether method 30 should wait for a set amount of time to allow the second cementitious layer to at least partially set before proceeding. If yes, method 30 waits for a set amount of time to pass in block 38. Otherwise an insulative core (e.g. insulative core 12) is placed over the second cementitious layer in block 39. An upper surface of the second cementitious layer may adhere (e.g. wet-bond) itself to a bottom face of the insulative core.

As described herein, block 35 is optional. Optional block 35 also need not be performed between the pouring of the first cementitious layer and the second cementitious layer. In some embodiments the one or more reinforcing members are positioned within the form prior to pouring the first cementitious layer. The reinforcing members may be elevated from a bottom surface of the form (e.g. using commercially available casting chairs or the like). In some embodiments the reinforcing members are positioned within the form only after the second cementitious layer is poured over the first cementitious layer. In some such embodiments the reinforcing members are positioned within the form after the second cementitious layer has at least partially set.

In block 40, a third cementitious composition may be poured over an upper face of the insulative core to cast a third cementitious layer (e.g. layer 17). A lower surface of the third cementitious layer may adhere (e.g. wet-bond) itself to the upper face of the insulative core. Block 41 determines whether method 30 should wait for a set amount of time to allow the third cementitious layer to at least partially set before proceeding with the construction of the panel. If yes, method 30 proceeds to block 42 where method 30 waits for a set amount of time to pass. Otherwise method 30 proceeds to optional block 43.

In block 43 one or more reinforcing members (e.g. reinforcing members 19B) are positioned within the form.

A fourth cementitious composition may be poured over the third cementitious layer to cast a fourth cementitious layer (e.g. layer 18) in block 44.

As described herein, block 43 is optional. Optional block 43 also need not be performed between the pouring of the third cementitious layer and the fourth cementitious layer. In some embodiments the one or more reinforcing members are positioned on an upper face of the insulative core prior to pouring the third cementitious layer. The reinforcing members may be elevated from the upper face of the insulative core (e.g. using commercially available casting chairs or the like). In some embodiments the reinforcing members are positioned within the form only after the fourth cementitious layer is poured over the third cementitious layer. In some such embodiments the reinforcing members are positioned within the form after the fourth cementitious layer has at least partially set.

In block 45 the panel is set. The panel may be set to a degree sufficient enough to be able to remove the panel from the form and/or transfer the panel across a factory floor. In block 46 the panel is extracted from the form. Preferably the form may be reused to make additional panels.

Adjacent cementitious layers (e.g. the first and second cementitious layers) may self-adhere (e.g. be wet-bonded) to each other. For example, the second cementitious layer may wet-bond itself to a partially set first cementitious layer. As another example, both the first and second cementitious layers may wet-bond themselves to each other.

Typically however wet-bonding as described herein is not possible (i.e. a strong enough chemical bond will not be generated) if a cementitious composition is dry or a cementitious layer required to wet-bond itself to another surface has substantially set.

In some embodiments surfaces of the form are treated to prevent one or more of the cementitious layers from adhering (e.g. wet-bonding) to the surfaces of the form.

Although method 30 describes casting cementitious layers on both faces of the insulative core this is not mandatory. In some cases method 30 is used to cast cementitious layers on only a single face of the insulative core.

The cementitious compositions for each of the cementitious layers may be picked based on desired characteristics for each of the cementitious layers as described elsewhere herein. The cementitious compositions used to cast the cementitious layers covering a face of the insulative core may be the same or different than the cementitious compositions used to cast the cementitious layers which cover the other face of the insulative core.

Depending on the densities of the cementitious layers that are poured, the reinforcing members may be buoyant, may shift within the cementitious layers, etc. resulting in the reinforcing members not being positioned properly within the cementitious layers. A roller may, for example, be used to properly position the reinforcing members. In some embodiments a porcupine roller may be used. In some embodiments the reinforcing members are properly positioned once the cementitious layers at least partially set as described elsewhere herein. In some embodiments the reinforcing members are secured in place by coupling the reinforcing members to other components of the panel.

In some embodiments reinforcing members are placed into each of the cementitious layers. In some such embodiments reinforcing members are pre-positioned at different heights corresponding to each of the different layers of the layers the reinforcing members will be placed into (e.g. using casting chairs having different heights).

In some embodiments reinforcing members are placed directly into a cementitious composition used to cast a cementitious layer prior to the cementitious composition being poured into the form. This may be particularly advantageous when the reinforcing members comprise a plurality of fibers.

### Interpretation of Terms

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms.

Words that indicate directions such as “vertical”, “transverse”, “horizontal”, “upward”, “downward”, “forward”, “backward”, “inward”, “outward”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

For example, while processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times.

In addition, while elements are at times shown as being performed sequentially, they may instead be performed simultaneously or in different sequences. It is therefore intended that the following claims are interpreted to include all such variations as are within their intended scope.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

Various features are described herein as being present in “some embodiments”. Such features are not mandatory and may not be present in all embodiments. Embodiments of the invention may include zero, any one or any combination of two or more of such features. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible).

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

What is claimed is:

1. A prefabricated building panel, the panel comprising:
an insulative core having first and second opposing faces;
a first cementitious layer coupled to the first face of the insulative core, the first cementitious layer comprising a volume of a first cementitious composition; and
a second cementitious layer coupled to the first cementitious layer, the second cementitious layer comprising a volume of a second cementitious composition, the first and second cementitious compositions having different physical properties.

2. A prefabricated building panel, the panel comprising:
an insulative core having first and second opposing faces;
a first cementitious layer coupled to the first face of the insulative core, the first cementitious layer comprising a volume of a first cementitious composition; and
a second cementitious layer coupled to the second face of the insulative core, the second cementitious layer comprising a volume of a second cementitious composition, the first and second cementitious compositions having different physical properties.

3. The building panel of claim 2 wherein said first cementitious layer comprises a plurality of cementitious layers each comprising a plurality of cementitious compositions having different physical properties.

4. The building panel of claim 2 wherein said second cementitious layer comprises a plurality of cementitious layers each comprising a plurality of cementitious compositions having different physical properties.

5. The building panel of claim 1 wherein the physical properties are selected from the group consisting of density, fire resistance, sound transmission, structural strength and moisture permeability.

6. The building panel of claim 1 wherein the first cementitious layer is chemically bonded to the first face of the insulative core.

7. The building panel of claim 1 wherein the second cementitious layer is chemically bonded to the first cementitious layer.

8. The building panel of claim 1 wherein one of the first and second cementitious layers has a density which is lower than a density of the other one of the first and second cementitious layers.

9. The building panel of claim 8 wherein the lower density cementitious layer has a density of at most 35 MPa and the higher density cementitious layer has a density greater than 35 MPa.

10. The building panel of claim 9 wherein the lower density cementitious layer has a density between 5 MPa and 35 MPa.

11. The building panel of claim 8 wherein the lower density cementitious layer is more fire resistant than the higher density cementitious layer.

12. The building panel of claim 8 wherein the lower density cementitious layer can withstand heat at 1800 degrees Fahrenheit for at least two hours.

13. The building panel of claim 8 wherein the lower density cementitious layer is more sound resistant than the higher density cementitious layer.

14. The building panel of claim 8 wherein the lower density cementitious layer has a sound resistance of at least 50 STC.

15. The building panel of claim 8 wherein the lower density cementitious layer comprises a cement, at least one polymer and at least one aggregate.

16. The building panel of claim 15 wherein the lower density cementitious layer comprises CSA cement, the at least one polymer and perlite.

17. The building panel of claim 16 wherein the lower density cementitious layer further comprises one or both of vermiculite and ceramic.

18. The building panel of claim 8 wherein the higher density cementitious layer has a density in the range of 35 MPa to 200 MPa.

19. The building panel of claim 18 wherein the higher density cementitious layer has a density in the range of 35 MPa to 90 MPa.

20. The building panel of claim 18 wherein the higher density cementitious layer has a density in the range of 90 MPa to 200 MPa.

21. The building panel of claim 8 wherein the higher density cementitious layer has a higher structural strength than the lower density cementitious layer.

22. The building panel of claim 8 wherein the higher density cementitious layer has a compressive strength in the range of 120 PCF to 160 PCF.

23. The building panel of claim 8 wherein the higher density cementitious layer has a lower moisture permeability than the lower density cementitious material.

24. The building panel of claim 8 wherein the higher density cementitious layer has a vapor permeance of less than 2 US perms.

25. The building panel of claim 8 wherein the higher density cementitious layer comprises cement and at least one polymer.

26. The building panel of claim 25 wherein the higher density cementitious layer comprises CSA cement.

27. The building panel of claim 8 wherein the first cementitious layer is the lower density cementitious layer and the second cementitious layer is the higher density cementitious layer.

28. The building panel of claim 8 wherein the second cementitious layer is the lower density cementitious layer and the first cementitious layer is the higher density cementitious layer.

29. The building panel of claim 1 further comprising reinforcing members at least partially embedded within one or both of the first and second cementitious layers.

30. The building panel of claim 29 wherein the reinforcing members are embedded between the first and second cementitious layers.

31. The building panel of claim 29 wherein the reinforcing members comprise at least one of the group consisting of expanded metal mesh, welded wire mesh, fiberglass mesh, basalt mesh, basalt rebar, carbon fiber mesh, carbon fiber rebar, carbon nanotubes, Kevlar mesh and steel rebar.

32. The building panel of claim 29 wherein the reinforcing members comprise a plurality of fibers.

33. The building panel of claim 32 wherein the plurality of fibers comprise at least one of the group consisting of polymer fibers, fiberglass fibers, basalt fibers and carbon fiber fibers.

34. The building panel of claim 1 wherein one of the first and second cementitious layers has a smaller volume of cementitious material than the other one of the first and second cementitious layers.

35. The building panel of claim 34 wherein the cementitious layer which comprises the smaller volume of cementitious material spans a smaller surface area of the panel than the other cementitious layer.

36. The building panel of claim 34 wherein one of the first and second cementitious layers provides increased strength around an opening in the panel.

37. The building panel of claim 1 wherein one or both of the first and second cementitious layers have a thickness between 0.2 inches (about 0.5 cm) and 2 inches (about 5 cm).

38. The building panel of claim 1 wherein one or both of the first and second cementitious layers span across at least a majority of the first face of the insulative core.

39. The building panel of claim 1 further comprising:
a third cementitious layer coupled to the second face of the insulative core, the third cementitious layer comprising a volume of a third cementitious composition; and
a fourth cementitious layer coupled to the third cementitious layer, the fourth cementitious layer comprising a volume of a fourth cementitious composition, the third and fourth cementitious compositions having different physical properties.

40. The building panel of claim 39 wherein the physical properties of the third and fourth cementitious compositions are selected from the group consisting of density, fire resistance, sound transmission, structural strength and moisture permeability.

41. The building panel of claim 39 wherein the third cementitious layer is chemically bonded to the second face of the insulative core.

42. The building panel of claim 39 wherein the fourth cementitious layer is chemically bonded to the third cementitious layer.

43. The building panel of claim 39 wherein the third cementitious composition is the same as the first cementitious composition.

44. The building panel of claim 39 wherein the fourth cementitious composition is the same as the second cementitious composition.

45. The building panel of claim 39 further comprising reinforcing members at least partially embedded within one or both of the third and fourth cementitious layers.

46. A method for constructing a prefabricated building panel, the method comprising:
casting a first plurality of cementitious layers in a form configured for casting the panel, each layer in the first plurality of cementitious layers having a different cementitious composition, each cementitious composition having different physical properties; and
coupling a first face of an insulative core to an upper surface of the first plurality of cementitious layers.

47. The method of claim 46 wherein the physical properties are selected from the group consisting of density, fire resistance, sound transmission, structural strength and moisture permeability.

48. The method of claim 46 wherein the first face of the insulative core is chemically bonded to the upper surface of the first plurality of cementitious layers.

49. The method of claim 46 wherein adjacent layers in the first plurality of cementitious layers are chemically bonded together.

50. The method of claim 46 further comprising embedding reinforcing members within the first plurality of cementitious layers.

51. The method of claim 50 wherein the reinforcing members are positioned within the form prior to casting the first plurality of cementitious layers.

52. The method of claim 46 further comprising casting a second plurality of cementitious layers over a second face of the insulative core, the second face opposite the first face, each layer in the second plurality of cementitious layers having a different cementitious composition, each cementitious composition having different physical properties.

53. The method of claim 52 wherein the physical properties of the cementitious compositions of the second plurality of cementitious layers are selected from the group consisting of density, fire resistance, sound transmission, structural strength and moisture permeability.

54. The method of claim 52 further comprising embedding reinforcing members within the second plurality of cementitious layers.
